(19) United States
(12) Patent Application Publication
(10) Pub. No.: US 2024/0083755 A1
(43) Pub. Date: Mar. 14, 2024

(54) CO2 hydrogenation catalysts for the commercial production of syngas

(71) Applicant: Infinium Technology, LLC, Sacramento, CA (US)

(72) Inventors: Dennis Schuetzle, Grass Valley, CA (US); Robert Schuetzle, Sacramento, CA (US); Anja Rumplecker Galloway, San Rafael, CA (US); Orion Hanbury, Sacramento, CA (US)

(73) Assignee: Infinium Technology, LLC, Sacramento, CA (US)

(21) Appl. No.: 18/445,227

(22) Filed: Jun. 5, 2023

Related U.S. Application Data
(62) Division of application No. 17/300,820, filed on Nov. 16, 2021.

(51) Int. Cl. C01B 32/40; B01J 21/00; B01J 21/04; B01J 21/10; B01J 23/755; B01J 23/78; B01J 35/10; B01J 37/02; B01J 37/08

(52) U.S. Cl. CPC C01B 32/40; B01J 21/005; B01J 21/04; B01J 21/10; B01J 23/755; B01J 23/78; B01J 35/1009; B01J 35/1014; B01J 35/1019; B01J 35/1023; B01J 37/0207; B01J 37/0225; B01J 37/082; C25B 15/081

(57) ABSTRACT

The present invention is generally directed to the production of low-carbon syngas from captured CO₂ and renewable H₂. The H₂ is generated from water using an electrolyzer powered by renewable electricity, or from any other method of low-carbon H₂ production. The improved catalysts use low-cost metals, they can be produced economically in commercial quantities, and they are chemically and physically stable up to 2,100° F. CO₂ conversion is between 80% and 100% with CO selectivity of greater than 99%. The catalysts don't sinter or form coke when converting H₂:CO₂ mixtures to syngas in the operating ranges of 1,300-1,800° F., pressures of 75-450 psi, and space velocities of 2,000-100,000 hr⁻¹. The catalysts are stable, exhibiting between 0 and 1% CO₂ conversion decline per 1,000 hrs. The syngas can be used for the synthesis of low-carbon fuels and chemicals, or for the production of purified H₂. The H₂ can be used at the production site for the synthesis of low-carbon chemical products or compressed for transportation use.

### CROSS REFERENCE TO RELATED APPLICATION

This application is a division of U.S. patent application Ser. No. 17/300,820, filed Nov. 16, 2021, which is incorporated by reference herein in its entirety.

### BACKGROUND OF THE INVENTION

The impact of ever-increasing CO₂ levels on the anthropogenic induced climate change have been widely documented (Shukla et al, IPCC, 2019). During 1970 to year-end 2019, global radiative forcing increased by an average of 3.03 Watts/square meter (W/m²), due to increases in the greenhouse gases, CO₂, CH₄, N₂O and H₂O, with a concurrent, average global temperature increase of 1.18° C. (2.13° F.). Climate models predict that average global temperatures could reach +2.00° C. (+3.60° F.) sometime between 2026 and 2028, and 2.36° C. (+4.28° F.) by year end 2031 compared to the average global temperature in 1970. Since CO₂ accounts for two thirds of these increases, rapid reductions in CO₂ emissions and atmospheric CO₂ are needed by no later than 2030 (Schuetzle, 2020).

CO₂ can be captured efficiently from emissions generated by industrial processes. Since CO₂ is a useful carbon source, the first priority should be to utilize this carbon source for the production of low-carbon fuels and chemicals, instead of sequestering the CO₂ in geological formations (Hepburn et al, 2019). CO₂ can also be captured from air (called Direct Air Capture—DAC) which allows for CO₂ collection from any location globally without being tied to an industrial source (Artz et al, 2018).

Since there are very few locations where suitable geological formations are available to sequester captured CO₂, it is much more suitable to produce fuels and chemical products from the CO₂. Furthermore, CO₂ is a valuable feedstock that can be used to produce low-carbon fuels and chemicals.

Syngas can potentially be commercially produced from the catalytic conversion of low-carbon H₂ and captured CO₂ mixtures. This catalytic process is referred to as CO₂ Hydrogenation, or the Reverse Water-Gas Shift (RWGS) reaction (Equation 1) (Daza et al, 2016; Vogt et al, 2019; Chen et al, 2020).

CO₂+H₂=CO+H₂O Eq. 1

The reaction is endothermic and requires heat to proceed. Elevated temperatures and efficient catalysts are required for significant CO₂ conversion to CO with minimal or no coking (carbon formation) or degradation in catalyst performance with time.

Since no commercially viable catalysts have been developed to date for the efficient production of syngas from H₂ and CO₂ mixtures, an improved catalyst and process has been developed and is described herein for the efficient commercial production of low-carbon syngas from mixtures of low-carbon H₂ and captured CO₂.

This low-carbon syngas is an excellent feedstock for producing a wide range of other chemical products, including liquid and gaseous hydrocarbon fuels, alcohols, acetic acid, dimethyl ether, and many other chemical products (Olah et al, 2009; Centi et al, 2009; Jiang et al, 2010; Schuetzle et al, 2010-2020; Fischer et al, 2016; Gumber et al, 2018; Tan et al, 2018; Li et al, 2019; NAS, 2019).

Many patent applications, patents and publications have described the development of RWGS catalysts for the conversion of H₂ and CO₂ mixtures to syngas (Bahmanpour et al, 2021). There is a second emerging approach that encompasses electrolysis processes for the conversion of mixtures of CO₂ and H₂O to syngas (Wang et al, 2016). However, this electrolysis approach is in the early research and development stages, and it is not considered as a viable commercial scale method at this time.

Most of the RWGS catalysts described in the current art operate at conditions that are not relevant to industrial relevant process conditions, or have significant limitations such as high costs, not amenable to large-scale manufacturing, or they have limited operational lifetime. We therefore have developed catalysts per the invention that are commercially viable and meet the following specifications outlined in Table 1.

TABLE 1
Quality and Performance Specifications for the Effective
Catalytic Conversion of H₂/CO₂ Mixtures to Syngas

| | |
|---|---|
| 1. | The catalyst is comprised of one or more low-cost metals selected from the alkali metals |
| | (Group 1), the alkaline earth metals (Group 2), the transition metal group, and the rare-earth |
| | metals which are impregnated and calcines on substrates that do not chemically react with the |
| | metals. The catalyst contains no precious metals. |
| 2. | One or more of the metals are formulated as metal salts (e.g., nitrates, acetates, carbonates, |
| | etc.) or metal hydroxides which are impregnated on the chemically inert substrates at a |
| | concentration from 0.0 to about 35 wt. %. |
| 3. | The inert substrates are one or more metal alumina spinels produced from the stoichiometric |
| | mixture of alumina with one of the following metals (Mg, Ca, Sr, Ba, Li, Rb, Cs, Fe, Co, Ni, |
| | Cu, Zn, La and Ce) by calcining up to 2,100° F. |
| 4. | The catalyst contains low-cost constituents with no precious metals comprising Rh, Pt, Au, |
| | Ag, Pd, or Ir. |
| 5. | The catalyst is robust, meaning a hardness of between 3 Mohs and 10 Mohs, more preferably |
| | between 4 Mohs and 7 Mohs (or equivalent on the Rockwell scale). |
| 6. | The catalyst is chemically and physically stable up to 2,100° F. By chemical and physical |
| | stable, it is meant that the surface area of the catalyst as measured by using the Brunauer- |
| | Emmet-Teller (BET) method, before and after thermal treatment is essentially the same and |
| | is considered stable when there is between 0 and 20% change in the measurement, and |
| | preferably between 0 and 10% change, and even more preferably between 0 and 5% change. |
| 7. | The catalyst can be loaded readily into catalytic reactors (e.g., tubular, or packed bed |
| | reactors). The pressure drop from the top to the bottom of the catalytic reactor is preferably |
| | between 0 and 50 psi, and even more preferably between 0 and 25 psi and even more |
| | preferably between 0 and 10 psi. |
| 8. | Catalyst activation should be able to be carried out in-situ in the reactor. The activation gas |
| | for the catalyst activation process should be readily available. Preferably the catalyst |
| | activation can be accomplished by using a gas comprising hydrogen. More preferably the |
| | catalyst activation can be accomplished using a gas comprising hydrogen and carbon dioxide. |
| 9. | The CO₂ to CO conversion efficiency is between 70% and 100%, but preferably between |
| | 75% and 100% at space velocities of between 2,000 hr⁻¹ and 1,000,000 hr⁻¹. |
| 10. | The CO₂ to CO conversion occurs at temperatures between 1,300° F. and 1,800° F., and |
| | pressures above 50 psi. |
| 11. | The catalyst does not coke (e.g., form carbon deposits), meaning that during the conversion |
| | of carbon dioxide to carbon monoxide, the percent carbon as measured on the catalyst is |
| | between 0 and 1% by weight, and more preferably between 0 and 0.1% by weight. |
| 12. | The catalyst during testing under planned commercial operating conditions meets the |
| | performance criteria such that CO₂ conversion declines by between 0 and 1% per 1000 hours |
| | of operation, and more preferably between 0 and 0.5% per 1000 hours of operation. |

### FIELD OF THE INVENTION

The field of the invention is the application of improved catalysts for the conversion of renewable H₂ and captured CO₂ to syngas, which is then used concurrently to produce low-carbon fuels and chemicals. The improved catalysts use low-cost metals, they can be produced economically in commercial quantities, and they are chemically and physically stable up to 2,100° F. CO₂ conversion efficiencies are between 80% and 100% with CO selectivity of greater than 99%. The catalysts don't sinter or form coke when converting H₂:CO₂ mixtures to syngas at 1,300-1,800° F., 75-450 psi and space velocities of 2,000-100,000 hr⁻¹. The catalysts are robust, exhibiting a reduction in CO₂ conversion of between 0 and 1.0% per 1000 hours.

### DESCRIPTION OF RELATED ART

Iwanani et al (1995) developed a catalyst comprised of transition metals with rare metals (such as Ni, Fe, Ru, Rh, Pt, W, Pd, Mo) on a ZnO/Al₂O₃ substrate for the conversion of CO₂ and H₂ mixtures to CO, targeting specifically catalytic performance with feeds containing H₂S. They achieved relatively low conversions of CO₂ of up to 37% at 1,100° F. at 3,000 hr⁻¹ for a 12.4% Ni/21.2% Zn catalyst without significant loss of catalyst activity after 150 hours but testing for longer periods was not carried out. This catalyst doesn't meet any of the specifications in Table 1.

Dupont et al (2003) developed a catalyst consisting of 0.78% ZnO/0.21% Cr₂O₃/0.01% NiO for the conversion of an H₂/CO₂ (3.5/1.0 v/v) mixture to CO. The CO₂ conversion efficiency was 36% with a 92% CO and 8% CH₄ selectivity at 950° F., a pressure of 580 psi, and a space velocity of 5.0 hr⁻¹. No data was presented on the efficiency of the catalyst with time. This catalyst does not meet all of the criteria outlined in Table 1.

Kim et al (2014) determined the CO₂ hydrogenation efficiency for a BaZr_{0.8}Y_{0.16}Zn_{0.04}O₃ perovskite catalyst with a 1/1 H₂/CO₂ blend at 1,110° F. and 15 psi. They achieved a low 38% conversion of CO₂ with a CO selectivity of 97%. The long-term catalyst durability was not determined since the catalyst was only run for 5 hours.

Chen et al (2015) reported the synthesis of a nano,intermetallic catalyst (InNi₃Co_{0.5}) that proved to be active and selective for the RWGS reaction. The catalyst was fabricated by carburizing the In—Ni intermetallic base which produced dual active sites on the catalyst surface. They achieved a moderate 52-53% CO₂ conversion for 150 hours at 1125° F. at high gas hourly velocities of 30,000 hr⁻¹. As based upon its structure, this catalyst may meet criteria #3 and #7. It would be difficult and costly to manufacture this catalyst in multiple ton quantities (criteria #1 and #2) and it is not known if can be used commercially in traditional catalytic reactors (criteria #5 and #6). This catalyst does not meet CO₂ to CO conversion efficiency requirements (criteria #8) and CO production selectivity. Since this catalyst was only tested for 150 hours, its stability and lifetime are not known.

Daza and Kuhn (2016) developed a La/Sr (3.0/1.0 w/w) catalyst impregnated on an FeO₃ substrate. They observed a 16% conversion of H₂/CO₂ (1.0/1.0 v/v) to CO with a 95% selectivity at 1,300° F. and 15 psi. The CO₂ conversion efficiency and CO selectivity were relatively constant over the period of a 150-hr. test. This catalyst meets criteria #1, #7 and #9 presented in Table 1. Since this catalyst was only run for 150 hrs. its long-term lifetime is not known.

Daza et al (2016) determined the CO₂ hydrogenation efficiency for a La_{0.75}Sr_{0.25}FeO₃ perovskite catalyst with a 1/1 H₂/CO₂ (v/v) blend at 1,020° F. and 15 psi. They achieved a very low 15% conversion of CO₂ with a CO selectivity of 95%. The long-term catalyst durability was not determined since the catalyst was only run for less than 24 hours. In summary, no data has been published to date that indicates perovskites could be acceptable catalysts for CO₂ hydrogenation.

Alumina has been widely studied as a catalyst support for both CO₂ hydrogenation and dry reforming of methane (DRM). The benefits of alumina lay primarily in its high surface area, low cost and stability at high temperatures. It is also relatively cheap compared to other support materials. Yang et al (2018) synthesized a 10% Ni/20% CeO₂ catalyst on γ-Al₂O₃. They tested this catalyst with a 4/1 H₂/CO₂ (v/v) blend at 1,300° F., 15 psi and a space velocity of 400 k hr⁻¹. They observed a CO₂ conversion of 67%, a CO selectivity of 90% and a CH₄ selectivity of 10%. The catalyst efficiency dropped by 37% after 50 hrs. due to carbon formation and Ni sintering. Therefore, this is not a viable commercial catalyst.

While a Ni catalyst on Al₂O₃ substrate is a potential RWGS catalyst, the spinel nickel aluminate NiAl₂O₄ is easily formed, which can result in at least some loss of activity (Ryu et al, 2021). However, the resistance to coke formation of Ni/Al₂O₃ is highly dependent on the catalyst structure and composition. At high temperatures, the formation of the spinel phase NiAl₂O₄ results in increased resistance to coke formation. This is a result of the strengthening of the Ni—O bond in NiAl₂O₄ with respect to NiO crystal, thus increasing the difficulty of Ni₂+ reduction to elemental nickel (Hu et al, 2004).

Magnesia is a promising support for due to its enhanced chemisorption of CO₂ and high basicity. The benefits of magnesia and alumina can also be combined in mixed MgO—Al₂O₃ supports. The effect of the increased basicity and specific surface area has been reported by Jun et al using a catalyst for dry reforming of methane (Jun et al, 2015). The influence of the Mg/Al on the catalytic activity and catalyst lifetime remains unclear. Also, none of the catalysts reported fully meets the requirements stated in Table 1.

Depending on the reaction conditions and preparation methods of the catalysts, mixed MgO—Al₂O₃ systems doped with nickel both form spinels from the respective components. Based on a systematic study with varying nickel content in NiₓMg₁₋ₓAl₂O₄, Park et al reported that RWGS conversion was preferred at high magnesium atomic ratios (2021). The results which were supported by DFT calculations, indicating that CO selectivity increased with increasing magnesium content. Zhang et al (2021) described a 0.43% Ni on MgAl₂O₄ catalyst for CO₂ hydrogenation of a 1/1 H₂/CO₂ blend at 1,472° F. They observed a modest 46% CO₂ conversion efficiency with no discernable loss in conversion efficiently after 75 hours. However, this efficiency doesn't meet the CO₂ conversion efficiency of between 70% and 100% above 1,300° F. and above 50 psi as outlined in Table 1. They didn't report CO production selectivity and the long-term deactivation rate of the catalyst is unknown.

The preparation of mixed Ni—Mg—Al—O phases has also been reported for the dry reforming of methane (DRM), where hydrotalcite-like mixed layered hydroxides were thermally decomposed, showing high activity and enhanced stability (Bhattacharyya et al.). Bhattacharyya et al. also compared the catalytic activity to commercial NiO supported catalyst. Hydrotalcite is a naturally occurring layered mineral, discovered in Sweden in 1842, with the chemical formula: Mg₆Al₂(OH)₁₆CO₃.4H₂O, a name stemming from the high-water content of the material as well as its resemblance to talc. It can also easily be synthesized by co-precipitation methods (Cavani et al, 1991). Many minerals with different molecular compositions but with similar empirical elemental structures have been reported. The term hydrotalcite (hydrotalcite-like compounds—HTs, layered double hydroxides—LDHs) is used to describe a large group of naturally occurring minerals and synthetic materials that possess the typical layered structure of hydrotalcite. The general formula of hydrotalcites can be summarized as: [M²⁺₁₋ₓM³⁺ₓ(OH)₂][(Aⁿ⁻_{x/n})·mH₂O] where M²⁺, M³⁺ are di- and tri-valent cations; A are interlayer anions; and x is the mole fraction of trivalent cations. The part [M²⁺₁₋ₓM³⁺ₓ(OH)]₂ describes the composition of brucite-like layers and [(Aⁿ⁻_{x/n})·mH₂O] describes the composition of interlayer spaces.

For the DRM catalyst synthesis, nickel was introduced using various methods including incipient wetness impregnation, ion-exchange, as well as co-precipitation. Nickel based hydrotalcite based catalysts have been considered for DRM and are well investigated.

Ni-Hydrotalcite catalysts with low nickel content are highly active towards CO₂ conversion, pointing at a simultaneous occurrence of reverse water gas shift (RWGS) (Lin et al, 2021). Numerous heterogeneous catalysts have been developed based on the cation-exchange ability of the Brucite layer, the anion-exchange ability of the interlayer, the surface tunable basicity, as well as the adsorption capacity (Debek et al, 2017; U.S. Pat. No. 8,388,987B2, 2013). Hydrotalcites have also been found for the production and processing of polymers, as neutralizing additives, or as part of building materials (Figueras et al, 2010; Sikander et al, 2017). However, to our knowledge there are no reports on the application of hydrotalcites in commercial RWGS catalysts, either with or without the additional metal active sites such as for example Ni.

Hydrotalcite based materials were also reported as possible solid sorbents for pressure swing CO₂ adsorption, a technology known as sorption-enhanced water-gas shift (SEWGS). Hydrotalcites showed high thermal and mechanical stability with sufficiently high cyclic working capacity and fast adsorption kinetics. The regeneration step (desorption of CO₂ by feeding steam to the adsorbent) is slower and limits the cyclic working capacity of the adsorbent. It was found that a higher operating temperature is beneficial because of enhanced desorption kinetics. Steam induces the desorption of a second adsorption site available for CO₂ which cannot be desorbed with N₂ (Boon et al, 2014). Calcination of hydrotalcites leads to dehydration, dihydroxylation and decarbonation, and eventual formation of the spinel. While the formation of the spinel phase from alumina and magnesia precursors is performed at temperatures above 1500° C., spinel phase forms at significantly lower temperatures during the calcination of hydrotalcites. When applying hydrotalcite precursors for the synthesis of commercial RWGS catalysts, the spinel phase can form as low as 700° C. (Jatav et al, 2016).

Bahmanpour et al (2019) studied an in situ formed Cu—Al spinel as an active substrate for the hydrogenation of CO₂ with H₂ into syngas. They used co-precipitation followed by hydrogen treatment to form the Cu—Al spinel with excess Cu in different weight ratios. A 4% Cu catalyst on the Cu—Al spinel was found to be the most efficient for CO₂ conversion. A low CO₂ conversion rate of 47% at 1,110° F. was achieved at relatively high space velocities with no detectable deactivation after a 40-hr. test. In comparison, a 4% Cu on gamma-alumina converted 33% of the CO₂ at 1,110° F. This catalyst meets criteria #1 and it possibly meets criteria #2, #3, #5, #6 and #7. However, copper containing catalysts tend to deactivate over time by sintering at high temperatures, which is problematic especially for the Cu excess formulation. In addition, this catalyst formulation needs to be tested for 1,000 hrs. or longer to assess long-term lifetime (criteria #10).

Table 2 summarizes the above catalytic systems and other potential catalysts for the catalytic CO₂ hydrogenation to CO. Most of these catalysts were tested for less than 48 hrs. which is not a sufficient length of time to assess catalyst durability. Since the lifetime of a commercial catalyst needs to be 2 years or longer, the reduction in CO₂ conversion must be between 0% and 1.0% conversion decline per 1000 hours.

Since these catalysts will be run in commercial reactors, they need to operate efficiency at pressures above 50 psi, and preferably above 150 psi. All the catalysts listed in Table 2 have been evaluated at 15 psi, except for Dupont et al, 2003; Kharaji et al, 2012; and Chen et al, 2019 who tested their catalyst at 300, 150 and 145 psi, respectively.

TABLE 2
Prior Art Summary for Catalytic CO₂ Hydrogenation to CO

| | | H₂/CO₂ | T | P | SV | (−)CO₂ | (+)CO | (+)CH₄ | Time | (−)CO₂/dt |
|---|---|---|---|---|---|---|---|---|---|---|
| Reference | Catalyst Formulation | ratio | (° F.) | (psi) | (khr⁻¹) | (%) | (%) | (%) | (hrs.) | (%/100 hr) |
| Chen (2003) | 9% Cu/1.9% K on | 1.0 | 1,100 | 15 | 0.4 | 13 | 13 | 0 | <48 | nd |
| | SiO₂ | | | | | | | | | |
| Dupont (2003) | 0.78% ZnO/0.21% | 3.5 | 950 | 300 | 5.0 | 36 | 33 | 3 | <48 | nd |
| | Cr₂O₃/0.01% NiO | | | | | | | | | |
| Wang (2008) | 2% Ni on CeO₂ | 1.0 | 1,400 | 15 | tbd | 40 | 40 | 0 | <48 | nd |
| Kharaji (2012) | γ-Al₂O₃ | 1.0 | 1,100 | 150 | 30.0 | 16 | nd | nd | 15 | 34.0 |
| Kharaji (2012) | Fe—V₂O₅ on γ-Al₂O₃ | 1.0 | 1,100 | 150 | 30.0 | 25 | nd | nd | 15 | 80.0 |
| Kim (2012) | 1% Pt on TiO₂ | 1.4 | 1,600 | 15 | 0.4 | 48 | 48 | 0 | <48 | nd |
| Kim (2012) | 1% Pt on γ-Al₂O₃ | 1.4 | 1,100 | 15 | 0.04 | 42 | 42 | 0 | <48 | nd |
| Lu (2014) | 3% NiO on CeO₂ | 1.0 | 1,400 | 15 | tbd | 45 | 45 | 0 | <48 | nd |
| Kharaji (2014) | 7% Ni-5% Mo on | 1.0 | 1,300 | 15 | 30.0 | 35 | nd | nd | 60 | 5.0 |
| | γ-Al₂O₃ | | | | | | | | | |
| Kharaji (2014) | 9% Mo on γ-Al₂O₃ | 1.0 | 1,300 | 15 | 30.0 | 15 | nd | nd | 60 | 22.0 |
| Kim (2014) | 3% NiO/CeO₂ | 1.0 | 1,100 | 15 | 2.7 | 38 | 32 | 6 | <48 | nd |
| Kim (2014) | BaZr_{0.8}Y_{0.16}Zn_{0.04}O₃ | 1.0 | 1,100 | 15 | 2.7 | 38 | 37 | 1 | 3 | nd |
| | perovskite | | | | | | | | | |
| Lortie (2014) | 10% CuNi₄ Solid | 1.0 | 1,300 | 15 | 282 | 38 | 38 | 0 | <48 | nd |
| | Solution on | | | | | | | | | |
| | Sm/CeO₂ | | | | | | | | | |
| Lortie (2014) | 1% Pt on Sm/CeO₂ | 1.0 | 1,300 | 15 | 282 | 40 | 40 | 0 | <48 | 1.0 |
| Landau (2015) | 90% Fe on Fe—Al₂O₃ | 1.0 | 950 | na | 0.02 | 36 | 13 | 9 | <48 | nd |
| | Spinel | | | | | | | | | |
| Sun (2015) | 10% Ni/Ce/ZrO | tbd | 1,400 | 15 | tbd | 49 | 49 | 0 | 80 | <1.0 |
| Daza (2016) | 1.0% La/0.75% Sr/ | 1.0 | 1,000 | 15 | 130 | 16 | 15 | 1 | 155 | <1.0 |
| | 0.25% FeO₃ perovskite | | | | | | | | | |
| Zhang (2016) | Cu on Mo₂C | 3.0 | 1,100 | 15 | 300 | 38 | 36 | 2 | 40 | 100.0 |
| Goncalves (2017) | 2.4% Ni on SiO₂ | 4.0 | 1,500 | 15 | na | 73 | 73 | 0 | 40 | nd |
| | sputter deposited | | | | | | | | | |
| Goncalves (2017) | 2.4% Ni on SiO₂ | 4.0 | 1,500 | 15 | na | 57 | 57 | 0 | 40 | nd |
| Pastor (2017) | Cs/Fe/Cu on γ-Al₂O₃ | 4.0 | 1,400 | 15 | 25 | 70 | 70 | 0 | 50 | nd |
| Choi (2017) | 4% Pd, Cu, Ni or Ag | 3.0 | 1,475 | 15 | 12 | 68 | 68 | 0 | 10 | nd |
| | on γ-Al₂O₃ | | | | | | | | | |
| Zhuang (2017) | 0.5% Ru/40% Cu/ZnO(1:1) | 4.0 | 930 | 40 | 40 | 40 | 38 | 2 | 25 | 100.0 |
| | on γ-Al₂O₃ | | | | | | | | | |
| Zhuang (2017) | 40% Cu/ZnO(1:1) on | 4.0 | 930 | 40 | 40 | 22 | 38 | 2 | 70 | 28.6 |
| | γ-Al2O3 | | | | | | | | | |
| Wang (2017) | 3% Co on CeO₂ | 1.0 | 1,100 | 15 | 200 | 30 | 98 | 2 | 50 | >25 |
| Alamer (2018) | 10% Cu on Al₂O₃ | 1.0 | 850 | 15 | 76 | 3 | 2 | 1 | 6 | nd |
| Alamer (2018) | 10% Cu on MgO | 1.0 | 850 | 15 | 76 | 10 | 3 | 7 | 6 | nd |
| Alamer (2018) | 5% Cu on MgO | 1.0 | 850 | 15 | 76 | 20 | 15 | 5 | 6 | nd |
| Alamer (2018) | 10% Cu on MgO | 1.0 | 1,475 | 15 | 76 | 48 | 48 | 0 | 6 | nd |
| Pastor- | 5% Cs/15% Fe on | 4.0 | 1,475 | 15 | 12 | 75 | 75 | 0 | 40 | 1.5 |
| Perez (2018) | γ-Al₂O₃ | | | | | | | | | |
| Yang (2018) | 10% Ni/20% CeO₂ | 4.0 | 1,400 | 15 | 30 | 67 | 61 | 6 | 50 | 74.0 |
| | on γ-Al₂O₃ | | | | | | | | | |
| Bahmanpour (2019) | 4% Cu on Cu—Al₂O₃ | 1.0 | 1,100 | 15 | 300 | 47 | 47 | 0 | 40 | 7.0 |
| | Spinel | | | | | | | | | |
| Bahmanpour (2019) | 6% Cu on γ-Al₂O₃ | 1.0 | 1,100 | 15 | 30 | 47 | 47 | 0 | 40 | 23.0 |
| Bahmanpour (2019) | 4% Cu/ZnO on | 1.0 | 1,100 | 15 | 30 | 33 | 33 | 0 | 40 | 32.0 |
| | γ-Al₂O₃ | | | | | | | | | |
| Chen (2019) | InNi₃C_{0.5} | 3.0 | 1,100 | 145 | 22 | 53 | 50 | 3 | 150 | 1.3 |
| He (2019) | MnO₂ | 1.0 | 1,560 | 15 | 40 | 50 | 50 | 0 | <48 | nd |
| Ranjbar (2019) | 15% Ni/on MgAl₂O₄ | 1.0 | 1,300 | 15 | 24 | 40 | 38 | 2 | 15 | 1.3 |
| | spinel | | | | | | | | | |
| Zhang (2021) | MgAl₂O₄ spinel | 1.0 | 1,472 | 15 | 225 | 38 | nd | nd | 75 | <0.5 |
| Zhang (2021) | 0.43% Ni on | 1.0 | 1,472 | 15 | 225 | 46 | nd | nd | <48 | nd |
| | MgAl₂O₄ spinel | | | | | | | | | |

### BRIEF SUMMARY OF THE INVENTION

The present invention is generally directed to the production of low-carbon syngas from captured CO₂ and renewable H₂. The H₂ is generated from water using an electrolyzer powered by renewable electricity, or from any other method of low-carbon H₂ production. The improved catalysts use low-cost metals, they can be produced economically in commercial quantities, and they are chemically and physically stable up to 2,100° F. CO₂ conversion efficiencies are between 80% and 100% with CO selectivity of greater than 99%. The catalysts don't sinter or form coke when converting H₂:CO₂ mixtures to syngas in the operating ranges of 1,300-1,800° F., pressures of 75-450 psi, and space velocities of 2,000-100,000 hr⁻¹. The catalysts are stable, exhibiting between 0 and 1.0% reduction in conversion or selectivity per 1,000 hrs. The syngas can be used for the synthesis of low-carbon fuels and chemicals, or for the production of purified H₂. The H₂ can be used at the production site for the synthesis of low-carbon chemical products or compressed for transportation use.

### BRIEF DESCRIPTION OF THE DRAWING

FIG. 1 describes the typical relationship of temperature with CO₂ conversion to CO using the improved catalysts of the invention.

### DETAILED DESCRIPTION OF THE INVENTION

In this section we describe our improved catalyst formulations which has been demonstrated to meet the performance and quality requirements presented in Table 1.

Four types of improved CO₂ hydrogenation or Reverse Water Gas Shift (RWGS) catalysts are described in these embodiments.

Type A. Metal-Spinel Catalysts - Pure alumina is an amphoteric substance, as it can react with both acids and bases. Depending on the morphology and crystal structure present the basicity of alumina can be complex. Acidic alumina catalyzes reactions that are typically acid catalyzed (Pines et al, 1960). However, several spinels produced from the high-temperature calcination of alumina with the Group 1 metals (Li, Cs, Rb) and Group 2 metals (Mg, Ca, Sr, Ba and Be) form metal aluminates that have defined and usually basic surface properties, also due to the increased surface concentrations of the hydroxy (—OH) groups.

Formates are formed when H₂/CO₂ mixtures react with these hydroxy groups according to Equation 2.

H₂+CO₂=HCOO-Metal Aluminate+H₂O (Eq. 2)

These formates decompose rapidly at high temperatures in the presence of H₂ to form CO (Equation 3) with a high selectivity. Therefore, some of these spinels are excellent CO₂ hydrogenation catalysts.

2HCOO-Metal Aluminate+H₂=2CO+2H₂O (Eq. 3)

A spinel of the invention is any class of minerals or synthetically produced minerals with the general chemical form of AB₂X₄. For the invention, X is oxygen, B can be chosen from the group comprising aluminum, iron, chromium, cobalt, and vanadium. A is chosen from a group comprising Mg, Zn, Fe, Mn, Cu, Ni, Li, Cs, Rb, Mg, Ca, Sr, Ba, Be, and Ti. In one embodiment of the invention, the catalyst is a metal aluminate such that B is Aluminum, and X is Oxygen.

Type B. Metal Impregnated Metal-Spinel Catalysts—When selected Group 1 (alkali metals such as Li, Cs, Rb) and/or Group 2 (alkaline earth metals such as Mg, Ca, Sr, Ba, and Be) are impregnated on selected spinels in the appropriate levels, the surface abundance of hydroxy groups increases, resulting in their improved efficiency for CO₂ hydrogenation. The addition of these elements is believed to enhance the chemisorption of CO₂ due to their impact on basicity, total pore volume and surface are. Dopants may be Ni, Cu, Ce, Zr, Ti, La, or the early Lanthanides. When two or more impregnated metals on the metal aluminate spinel are calcined up to a temperature of 2,100° F., a solid solution is formed. This solid solution represents excellent catalyst for CO₂ hydrogenation. Ni and Mg form a solid solution, Ni₂Mg, at 2,050° F. on Mg-Aluminate since Ni and Mg both crystallize in a face-centered cubic structure, and they have similar electronegativities and valences. Ni also forms a solid solution with Cu, NiCu₃, at 2,050° F. since Ni and Cu both crystallize in a face-centered cubic structure, and they have similar atomic radii, electronegativities and valences. Solid solutions are formed when two of the metals impregnated on the metal aluminate spinel have similar crystal structures, atomic radii, electronegativities and valences. Dopants may be present as extra framework and unincorporated into the spinel or may be supported on the Metal-Spinel Catalyst, or especially at higher concentrations be both supported by spinel or be present in close proximity inside a physical mixture.

The RWGS catalyst is operated in the 1,300-1,800° F. range in order to achieve CO₂ conversion efficiencies above 70%, which is a temperature range where many materials sinter at increased rates as they approach their melting point. The solid solution used in the catalyst should be a solid at these temperatures. Therefore, viable solid solutions are those that are formed in the 1,850-2,100° F. range. Ni₂Mg and NiCu₃ are stable solids at these catalyst operating temperatures, and they have excellent performance as CO₂ hydrogenation catalysts. The solid solution, Cu₂Mg, is formed from 2 moles of Cu and 1 mole of Mg at 1,300° F. and it doesn't qualify as a candidate since the solution is a liquid at the catalyst operating temperatures.

Type C. Enjineered Layered Solids—Hydrotalcite based materials are used as catalysts for RWGS. These materials include natural hydrotalcite as well as synthetic highly engineered anionic clays or layered double hydroxides (LDH). Natural hydrotalcites may be used as additives, or as precursors for further synthesis. Synthetic Hydrotalcites are commercially available or may be prepared by coprecipitation methods.

Hydrotalcite is a layered double hydroxide (LDH)—Mg₆Al₂CO₃(OH)₁₆.4H₂O. Multiple structures containing loosely bound carbonate ions exist, which are known for their ion exchange capabilities as well as their ability to adsorb CO₂. Upon calcination the material decomposes to high surface area spinel, that can easily be rehydroxylated or recarboxylated. Full thermal decomposition will lead to a spinel that is known for its hardness and durability.

LDH's are structurally derived from the brucite (Mg(OH)₂) structure by the isomorphous substitution of M²⁺ ions by M³⁺ ions. The LDH layers are positively charged and charge neutrality is realized by the presence of interlamellar anions. When M³⁺ is Al³⁺ the mineral hydrotalcite is obtained. The uniquely high surface area of LHD as well as their surface basicity significantly improve the performance of RWGS. The surface area, chemical composition as well as basicity of the layered solid is engineered to optimize the performance of the commercial RWGS catalyst.

Type D. Perovskite Catalysts.—Similar to the materials of Type A, perovskite materials can be used as improved RWGS catalysts. Perovskite materials have the general chemical form of ABX₃. For the invention, X is Oxygen. A and B are cations. Perovskite materials can be chosen from simple perovskites such where A is chosen from the group comprising Sr, Ca, Ba, Mg, Fe, La, Ca, Pb, or Bi and B is chosen from the group comprising Al, Ti, Rb, Si, Fe, Yb or Mn. In addition, solid solution perovskite materials can also be used such as lanthanum strontium manganite, lanthanum aluminate-strontium aluminum tantalate (LSAT), lead scandium tantalate, or lead zirconate tantalate. These catalysts comprise perovskites or mixtures of various perovskites.

In the following embodiments that described the preferred catalyst compositions and catalyst performance, certain specific details provide a thorough understanding of various embodiments. Unless the context requires otherwise, throughout the specification and claims which follow, the word “comprise” and variations thereof, are to be construed in an open, inclusive sense, that is, as “including, but not limited to.”

### Catalyst Composition Embodiments

1. A reverse water gas shift (RWGS) catalyst for the conversion of H₂ and CO₂ mixtures into syngas comprising the process steps of: a) introducing a H₂ and CO₂ mixture, or b) a mixture of H₂ and CO₂ and light hydrocarbons, into a catalytic reactor in a catalytic conversion system to produce syngas or carbon monoxide. The product of the catalytic reactor is further reacted to produce at least one of the following products chosen from the list consisting of liquid fuels, methanol, propane, naphtha, and chemicals

2. A reverse water gas shift (RWGS) catalyst of embodiment 1 (Type A) which comprises: a) a metal-aluminate spinel having a surface area between 10 m²/g and 1000 m²/g, wherein the metal spinel is selected from a group consisting of:
a. Group 2 metals calcined with alumina to form Mg-aluminate, Ca-aluminate, Sr-aluminate, Ba-aluminate and Be-aluminate.
b. Group 1 metals calcined with alumina to form Li-aluminate, Rb-aluminate, and Cs-aluminate.
c. Transition metals calcined with alumina to form Fe-aluminate, Co-aluminate, Ni-aluminate, Cu-aluminate, and Zn-aluminate.
d. Rare-earth metals calcined with alumina to form La-aluminate, and Ce-aluminate.
e. The above specified metal spinels may be present individually, or as mixed oxides of some or all of the above.

3. A reverse water gas shift (RWGS) catalyst (Type B) which employs one of the metal-alumina spinels described in embodiment 2 with an impregnated metal dopant such but not limited to Mg, Ca, Sr, Ba, Li, Rb, Cs, Fe, Co, Ni, Cu, Zn, La and Ce. The metal dopant may not be chemically bond to the spinel. In some embodiments only one of the above elements may be added, while in other embodiments catalyst formulations may comprise complex mixtures of several of the above elements.

Metal dopants may be introduced by impregnation, or in some cases also by physical mixing of solid precursors with the spinel. The amount of metal precursor may range from 0 to 35 wt. % of a metal salt (e.g. nitrates, acetates, carbonates, etc.) or metal hydroxides, or a metal oxide. The formed material is then calcined at a temperature up to 2,100° F., thereby synthesizing a catalyst that is a metal-impregnated, metal-alumina spinel that has a surface area between 5 m²/g and 1000 m²/g.

4. A reverse water gas shift (RWGS) catalyst of embodiment 1 (Type C), which contains an engineered layered solid in which the engineered layered solid may embody 100% of the solid catalyst without any additional additives. A reverse water gas shift (RWGS) catalyst (Type C) which employs the use of engineered layered solids with an impregnated metal dopant such but not limited to Mg, Ca, Sr, Ba, Li, Rb, Cs, Fe, Co, Ni, Cu, Zn, La and Ce. The metal precursor may be a metal salt (e.g., nitrates, acetates, carbonates, etc.), or metal hydroxides, or a metal oxide. The engineered layered solid may embody 0-10% of catalyst formulation, 20-30% of catalyst formulation, 40-50% of catalyst formulation, 50-60% of catalyst formulation, 50-60% of catalyst formulation, 60-70% of catalyst formulation, 70-80% of catalyst formulation, or 80-90% of catalyst formulation. The remaining part of the formulation may be dopants or other additives needed to form a commercial catalyst. The metal dopant may not be chemically bond to the engineered layered solid. In some embodiments only one of the above elements may be added, while in other embodiments catalyst formulations may comprise complex mixtures of several of the above elements.

Metal dopants may be introduced by impregnation, or in some cases also by physical mixing of solid precursors with the engineered layered solid. The formed material is then calcined at a temperature up to 2,100° F. This reverse water gas shift (RWGS) catalyst (Type C) employs the use of natural occurring layered solid with an impregnated metal dopant such but not limited to Mg, Ca, Sr, Ba, Li, Rb, Cs, Fe, Co, Ni, Cu, Zn, La and Ce. The metal precursor may be a metal salt (e.g. nitrates, acetates, carbonates, etc.), or metal hydroxides, or a metal oxide. The natural occurring layered solid may embody 0-10% of catalyst formulation, 20-30% of catalyst formulation, 40-50% of catalyst formulation, 50-60% of catalyst formulation, 50-60% of catalyst formulation, 60-70% of catalyst formulation, 70-80% of catalyst formulation, or 80-90% of catalyst formulation. The remaining part of the formulation may be dopants or other additives needed to form a commercial catalyst. The metal dopant may not be chemically bond to the engineered layered solid. In some embodiments only one of the above elements may be added, while in other embodiments catalyst formulations may comprise complex mixtures of several of the above elements. Metal dopants may be introduced by impregnation, or in some cases also by physical mixing of solid precursors with the engineered layered solid. The formed material is then calcined at a temperature up to 2,100° F.

5. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Mg salt; b) Mg-alumina spinel according to embodiment 2 having a surface area between 10 m²/g and 1000 m²/g; mixed with up to 35 wt. % of a CaCO₃, MgCO₃, SrCO₃, CaO, MgO, or SrO; c) Mg-alumina spinel according to embodiment 2 having a surface area between 5 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce. d) Ca-alumina spinel according to embodiment 2 having a surface area between 10 m²/g and 1000 m²/g; impregnated with up to 35% of mixtures of primary, secondary; ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g. e) Mg-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100 ° F., resulting in a metal-impregnated, Mg-alumina spinel that has a surface area between 5 m²/g and 1000 m²/g.

6. A reverse water gas shift (RWGS) catalyst of embodiment 3 wherein the catalyst comprises the following components: a) Mg-alumina spinel according to embodiment 2 having a surface area between 10 m²/g and 1000 m²/g; impregnated with up to 35 wt. % of a Ca salt; b) Ca-alumina spinel according to embodiment 2 having a surface area between 10 m²/g and 1000 m²/g; mixed with up to 35 wt. % of a CaCO₃, MgCO₃, SrCO₃, CaO, MgO, or SrO; c) Ca-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d). Ca-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Ca-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Ca-alumina spinel that has a surface area between 5 m²/g and 1000 m²/g.

7. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Sr salt; b) Sr-alumina spinel according to embodiment 2 having a surface area between 10 m²/g and 1000 m²/g; mixed with up to 35 wt. % of a CaCO₃, MgCO₃, SrCO₃, CaO, MgO, or SrO; c) Sr-alumina spinel according to embodiment 2 having a surface area between 10 m2/g and 1000 m2/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Sr-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Sr-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Sr-alumina spinel that has a surface area between 5 m²/g and 1000 m²/g.

8. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Ba salt; b) Ba-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Ba-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Ba-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Ba-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Ba-alumina spinel that has a surface area between 5 m²/g and 1000 m²/g.

9. A reverse water gas shift (RWGS) catalyst of embodiment 3 wherein the catalyst comprises the following components: a) Mg-alumina spinel according to embodiment 2 having a surface area between 10 m²/g and 1000 m²/g; impregnated with up to 35 wt. % of a Li salt; b) Li-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Li-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Li-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Li-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Li-alumina spinel that has a surface area between 5 m²/g and 1000 m²/g.

10. A reverse water gas shift (RWGS) catalyst of embodiment 3 wherein the catalyst is comprises the following components: a) Mg-alumina spinel according to embodiment 2 having a surface area between 10 m2/g and 1000 m2/g; impregnated with up to 35 wt. % of a Rb salt; b) Rb-alumina spinel according to embodiment 2 having a surface area between 10 m2/g and 1000 m2/g; mixed with up to 35 wt. % of CaCO₃, MgCO₃, SrCO₃, CaO, MgO, or SrO; c) Rb-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Rb-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Rb-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Rb-alumina spinel that has a surface area between 5 m²/g and 1000 m²/g.

11. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Cs salt; b) Cs-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Ni-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Cs-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Cs-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Cs-alumina spinel that has a surface area between 5 m²/g and 1000 m²/g.

12. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Fe salt; b) Fe-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Fe-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Fe-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Fe-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Fe-alumina spinel that has a surface area between 5 m²/g and 1000 m²/g.

13. A reverse water gas shift (RWGS) catalyst of embodiment 3 wherein the catalyst is comprises the following components: a) Mg-alumina spinel according to embodiment 2 having a surface area between 10 m2/g and 1000 m2/g; impregnated with up to 35 wt. % of a Co salt; b) Ni-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Ni-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Co-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Co-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Co-alumina spinel that has a surface area between 5 m²/g and 1000 m²/g.

14. A reverse water gas shift (RWGS) catalyst of embodiment 3 wherein the catalyst is comprises the following components: a) Mg-alumina spinel according to embodiment 2 having a surface area between 10 m2/g and 1000 m2/g; impregnated with up to 35 wt. % of a Ni salt; b) Ni-alumina spinel according to embodiment 2 having a surface area between 10 m²/g and 1000 m2/g; mixed with up to 35 wt. % of CaCO₃, MgCO₃, SrCO₃, CaO, MgO, or SrO; c) Ni-alumina spinel according to embodiment 2 having a surface area between 10 m2/g and 1000 m2/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Ni-alumina spinel according to embodiment 2 having a surface area between 10 m2/g and 1000 m2/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, and a different metal spinel of embodiment 2 of at least 10 m²/g; e) Ni-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Ni-alumina spinel that has a surface area between 5 m²/g and 1000 m²/g.

15. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Cu salt; b) Cu-alumina spinel according to embodiment 2 having a surface area between 10 m²/g and 1000 m²/g; mixed with up to 35 wt. % of CaCO₃, MgCO₃, SrCO₃, CaO, MgO, or SrO; c) a Cu-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Cu-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as a different metal spinel of at least 10 m²/g; e) Cu-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Cu-alumina spinel that has a surface area between 5 m²/g and 1000 m²/g.

16. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Zn salt; b) Zn-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Zn-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Zn-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as a different metal spinel of at least 10 m²/g; e) Zn-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The.resulting formulation is calcined to up 2,100° F., resulting in a metal-impregnated, Zn-alumina spinel that has a surface area between 5 m²/g and 1000 m²/g.

17. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a La salt; b) La-alumina spinel according to embodiment 2 having a surface area between 10 m²/g and 1000 m²/g; mixed with up to 35 wt. % of CaCO₃, MgCO₃, SrCO₃, CaO, MgO, or SrO; c) La-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) La-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as a different metal spinel of at least 10 m²/g; e) a La-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, La-alumina spinel that has a surface area between 5 m²/g and 1000 m²/g.

18. A reverse water gas shift (RWGS) catalyst of embodiment 3 wherein the catalyst is comprises the following components: a) Mg-alumina spinel according to embodiment 2 having a surface area between 10 m²/g and 1000 m²/g; impregnated with up to 35 wt. % of a Ce salt; b) Ce-alumina spinel according to embodiment 2 having a surface area between 10 m²/g and 1000 m²/g; mixed with up to 35 wt. % of CaCO₃, MgCO₃, SrCO₃, CaO, MgO, or SrO; c) Ce-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce; d) Ce-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as a different metal spinel of at least 10 m²/g; e) a Zn-alumina spinel according to embodiment 2 having a surface area between 10 m²/g and 1000 m²/g; impregnated with up to 35% of mixtures of primary, secondary, ternary, or more mixtures of salt mixtures including but not limited to Mg, Ca, Sr, Ba, Li, Rb, Cs, Fe, Co, Ni, Cu, Zn, La and Ce, as well as a natural or engineered layered solid comprising 5-10% of the catalyst formulation, 20-30% of the catalyst formulation, 40-50% of the catalyst formulation, 50-60% of the catalyst formulation, 60-70% of the catalyst formulation, 70-80% of the catalyst formulation. The resulting formulation is calcined to up 2,100° F., resulting in a metal-impregnated, Ce-alumina spinel that has a surface area between 5 m²/g and 1000 m²/g.

19. Although the embodiments 5-18 cover the formulations of a CO2 hydrogenation catalyst that focuses on the impregnation of a specific metal on a metal-alumina spinel synthesized from the same metal, the various permutations of the other metals in embodiment 3 on the other metal-spinels in embodiment 2 are covered (e.g., Ni on Mg-aluminate; Ni on Ba-aluminate, etc.).

20. This embodiment comprises a reverse water gas shift (RWGS) catalyst (Type C) which employs one of the metal-alumina spinels described in embodiment 2 with a) the impregnation of up to 35 wt. % of two metal salts (e.g. nitrates, acetates, carbonates, etc.) or metal hydroxides selected from a group comprising Mg, Ca, Sr, Ba, Li, Rb, Cs, Fe, Co, Ni, Cu, Zn, La and Ce, which don't chemically bond to the spinel; b) calcining the metal-alumina spinel impregnated with the two or more metals at a temperature up to 2,100° F., thereby synthesizing a solid-solution of the two metals on the metal-alumina spinel.

21. The reverse water gas shift (RWGS) catalyst of embodiment 20 wherein the catalyst is produced by a process comprising the steps of: a) synthesizing a Mg-alumina spinel according to embodiment 2 having a surface area between 10 m²/g and 1000 m²/g; b) impregnating the spinel with up to 35 wt. % of a mixture of Ni and Mg; c) calcining the Ni- and Mg-impregnated, Mg-alumina spinel at a temperature up to 2,100° F.; d) thereby producing a solid-solution of the two metals that has the composition Ni₂Mg. Ni and Mg form a solid solution at 2,100° F. since Ni and Mg both crystallize in a face-centered cubic structure, have similar electronegativities and valences.

22. The reverse water gas shift (RWGS) catalyst of embodiment 20 wherein the catalyst is produced by a process comprising the steps of: a) synthesizing a Mg-alumina spinel according to embodiment 2 having a surface area between 10 m²/g and 1000 m²/g; b) impregnating the spinel with up to 35 wt. % of a mixture of Ni and Cu; c) calcining the Ni- and Mg-impregnated, Mg-alumina spinel at a temperature up to 2,100° F.; d) thereby producing a solid-solution of the two metals that has the composition NiCu₃. Ni and Cu form a solid solution at 2,100° F. since Ni and Cu both crystallize in a face-centered cubic structure, have similar atomic radii, electronegativities and valences.

### Catalyst Performance Embodiments

Most of the improved CO₂ hydrogenation catalysts described above in the Catalyst Composition Embodiments meet the commercial quality and performance specifications summarized in Table 1.

1. Low-Cost Constituents—The catalysts are formulated primarily using low-cost Group 1 elements (Alkali Metals) comprising Na, K, Li, Cs and Rb; the Group 2 elements (Alkaline Earth Metals): Mg, Ca, Sr, Ba and Be; the Transition Metals comprising Ni, Co, Fe and Cu; and the Rare-Earth elements comprising Ce, Y, La. It has been found that the addition of small quantities of precious metals (such as Au, Ag, Pt, Pd, Ir) do not improve the performance of these improved CO₂ hydrogenation catalysts.

2. Commercial Production—The substrates and catalysts are economically produced in multiple ton quantities using well established commercial-scale production processes. The metal alumina spinel substrates may be prepared by a) coprecipitation methods or b) by mixing appropriate molar quantities of a metal precursors and alumina particles to form a slurry, drying the slurry, and then calcining the mixture up to 2,600° F. The catalysts are prepared by the impregnation of the metal(s) on the metal-alumina spinel substrates followed by calcination up to 2,100° F.

3. Physically Robust—The disclosed catalysts have hardness of between 4 Mohs and 10 Mohs, or an equivalent Rockwell hardness. This high level of hardness eliminates the potential problem of catalyst breakage, cracking and ablation.

4. Chemically and Physically Stable—These a). metal-alumina spinels, b). metal impregnated metal metal-alumina spinels and c). solid solutions impregnated on the metal metal-alumina spinels maintain their chemical and physical properties (such as not melt) up to 2,100° F.

5. Compatible with Commercial Catalytic Reactors—The catalyst pellets, tablets, or hollow tablets are easy to load into catalytic reactors (tubular, or packed bed reactors). The pressure drop from the top to the bottom of the catalytic reactors is between 0 and 50 psi and usually between 0 and 25 psi. The activation of the catalyst (e.g., reduction with H₂) is carried out in-situ if required.

6. High CO₂ Conversion Efficiency—The CO₂ to CO conversion efficiency for H₂/CO₂ blends with ratios higher than 3.0/1.0 is between 70% and 100%, preferably between 75% and 100%, and more preferably between 80% and 100% at space velocities between 2,000 hr⁻¹ and 1,000,000 hr⁻¹ and temperatures between 1,300° F. and 1,800° F.

7. High CO Production Selectivity—The disclosed catalyst formulations have CO of at least 90%. Some of the preferred catalyst formulations have CO selectivities greater than 99% with methane selectivities below 1%, and CO selectivities as low as 0.1% in some cases.

8. Doesn't Coke or Change Composition—These improved catalyst formulations do not coke or change chemical composition during operation.

9. Long-Term Performance—Several of the improved CO₂ hydrogenation catalysts have been tested for more than 1,500 hrs. on stream and it has been determined that the reduction in CO₂ conversion is between 0 and 0.50% per 1000 hours.

### EXAMPLES

Example 1: Improved RWGS Catalyst Formulation A—A stream comprising CO₂ is produced by an industrial process or captured from ambient air. This CO₂ stream is fed to a CO₂ capture facility. The CO₂ capture facility uses methyl diethanolamine (MDEA) in an absorber tower to capture the CO₂. Relatively pure CO₂ is regenerated from the MDEA by heating. Low-carbon electricity from a wind farm, a solar farm, a nuclear power plant, or other low-carbon power sources is available at the site of the carbon capture facility. High-purity water is produced from locally available water. Low-carbon H₂ is produced from the purified water via electrolysis.

This reaction uses the low-carbon electricity to split the water into H₂ and O₂. The electrolyzer in this example is a PEM Electrolyzer. The electrolyzer produces two streams, H₂ and O₂.

This improved catalyst formulation A of embodiment 2 (above) is manufactured by a method comprising the steps of: a) synthesizing a metal-aluminate spinel having a surface area between 10 m²/g and 1000 m²/g, wherein the metal spinel is selected from a group comprising:
a. Group 2 metals calcined with alumina to form Mg-aluminate, Ca-aluminate, Sr-aluminate, Ba-aluminate and Be-aluminate.
b. Group 1 metals calcined with alumina to form Li-aluminate, Rb-aluminate, and Cs-aluminate.
c. Transition, metals calcined with alumina to form Fe-aluminate, Co-aluminate, Ni-aluminate, Cu-aluminate, and Zn-aluminate.
d. Rare-earth metals calcined with alumina to form La-aluminate, and Ce-aluminate.

The improved catalyst is used to convert the captured CO₂ and renewable H₂ stream into syngas. Example 1 provides the relationship between temperature and % CO₂ conversion to CO for the improved CO₂ hydrogenation catalyst. In this example, the H₂ to CO₂ ratio is 3.4/1.0, the pressure is 300 psig, and the space velocity is 20,000 hr⁻¹. The conversion of CO₂ varies from 75% to 83.5% from 1,250-1,650° F. with between 0 and 0.5% conversion reduction after 1,000 hrs. on stream. Since the catalysts at these relevant temperature ranges exhibits very little sintering, their lifetime is excellent. The CO selectivity is >99.5% with between 0 and 0.5% CH₄ selectivity. The dotted line is the trendline which shows that the relationship between CO₂ conversion and temperature is nearly linear.

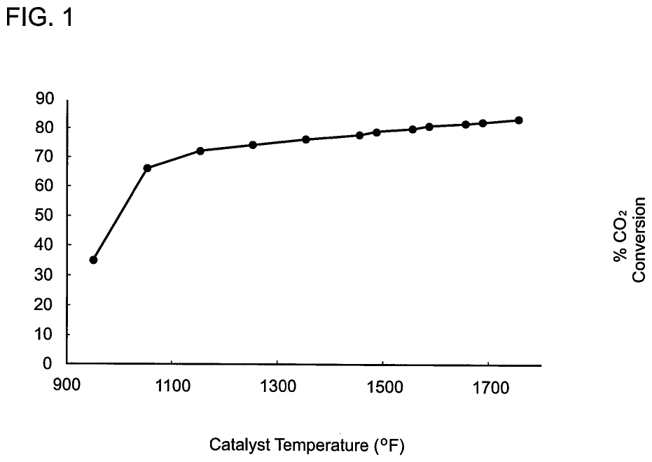

Example 1—The Typical Relationship between Temperature and % CO₂ Conversion to CO for the Improved RWGS Catalysts. FIG. 1 shows the typical relationship between Temperature and % CO₂ Conversion to O for the Improved RWGS Catalysts. The X-Axis is temperature in degrees Fahrenheit. The Y-Axis is the CO₂ Conversion in mole percent to CO. As can be seen at a temperature of 1200° F. to 1750° F., the CO₂ conversion is between 70 and 85%.

Example 2: Improved RWGS Catalyst Formulation B—This improved catalyst formulation B is described in embodiment #3 (above) as a metal on a metal aluminate. This type B CO₂ hydrogenation catalyst employs one of the metal-alumina spinels described in embodiment 2 with a) the impregnation of up to 35 wt. % of a metal salt (e.g. nitrates, acetates, carbonates, etc.) or metal hydroxide selected from a group comprising Mg, Ca, Sr, Ba, Li, Rb, Cs, Fe, Co, Ni, Cu, Zn, La and Ce, which don't chemically bond to the spinel; b) calcining the impregnated, metal-coated metal-alumina spinel at a temperature up to 2,100° F., thereby synthesizing a catalyst that is an metal-impregnated, metal-alumina spinel that has a surface area between 5 m²/g and 1000 m²/g.

In this example the catalyst is MgO or Mg(OH)₂ impregnated on a Mg-Alumina Spinel. The MgO or Mg(OH)₂ is reduced in-situ with H₂, producing Mg, MgO and Mg(OH)₂ on the surface of the spinel.

The improved catalyst is used to convert the captured CO₂ and renewable H₂ stream into syngas. In this example, the H₂ to CO₂ ratio is 3.4/1.0, the temperature is 1,650° F., the pressure is 300 psig, and the space velocity is 20,000 hr⁻¹. The conversion of CO₂ is 82% at 1,650° F. with between 0 and 0.5% conversion reduction after 1,000 hrs. on stream. The CO selectivity is greater than 99%.

Example 3: Improved RWGS Catalyst Formulation C—This improved RWGS catalyst C is described in embodiments 20-23 for the efficient conversion of CO₂ and H₂ into syngas by a process comprising the steps of: a) synthesizing a Mg-aluminate spinel having a surface area between 10 m²/g and 1000 m²/g; b) coating the spinel with up to 20 wt. % of Mg to provide a metal-coated spinel; c) impregnating the metal-coated spinel with a solution comprising water soluble nickel salts and either nitrate or acetate salts of rare-earth metals; d) calcining the impregnated, metal-coated spinel at a temperature up to 2,100° F., thereby synthesizing a catalyst that is an impregnated spinel that is comprised with up to 35 wt. % nickel and of 0.1 wt. % to 5.0 wt. % of the rare earth metals. The catalyst may contain 0.1 to 5 parts-by-weight of cerium, ruthenium, lanthanum, platinum, or rhenium, and 2 wt. % to 20 wt. % nickel per 100 parts-by-weight of the spinel support. As described in embodiment #21, the solid solution catalyst is Ni₂Mg.

Another improved catalyst type C for the efficient conversion of CO₂ and H₂ into syngas is produced by a process comprising the steps of a) synthesizing a Cu impregnated Cu-aluminate spinel having a surface area between 10 m²/g and 1000 m²/g; b) coating the spinel with up to 20 wt. % of Cu to provide a metal-coated spinel; c) impregnating the metal-coated spinel with a solution comprising water soluble Ni salts and either nitrate or acetate salts of rare-earth metals; d) calcining the impregnated, metal-coated spinel at a temperature up to 2,100° F., thereby synthesizing a catalyst that is an impregnated spinel that is comprised with up to 20 wt. % nickel and of 0.1 wt. % to 5.0 wt. % of the rare earth metals. As described in embodiment #22, the primary solid solution catalysts are NiCu₃.

The relationship between temperature and CO₂ conversion efficiency (Example #1) is similar for catalyst #1 and catalyst #2. The difference is that catalyst #1 has between 0 and 0.5% CH₄ selectivity compared to up to 7.0% CH₄ selectivity (depending upon temperature and pressure) for catalyst #2. However, catalyst #2 is more efficient at higher space velocities.

### REFERENCES

U.S. Patents

| | | |
|---|---|---|
| 7,718,832 B1 | May 2010 | Schuetzle et al |
| 8,388,987 B2 | March 2013 | Ikematsu et al |
| 8,394,862 B1 | March 2013 | Schuetzle et al |
| 8,741,001 B1 | June 2014 | Schuetzle et al |
| 9,090,831 B2 | July 2015 | Schuetzle et al |
| 9,476,002 B1 | October 2016 | Schuetzle et al |
| 9,611,145 B1 | April 2017 | Schuetzle et al |
| 9,631,147 B1 | April 2017 | Schuetzle et al |
| 10,478,806 B1 | November 2019 | Schuetzle et al |

U.S. Patent Applications

| | | |
|---|---|---|
| 2003/0113244 A1 | June 2013 | DuPont et al |

Foreign Patent Documents

| | | |
|---|---|---|
| GB 1995/2279583 A1 | November 1995 | Iwanani et al |
| AU 2015/203898 B2 | July 2015 | Landau et al |
| WO 2018/219992 A1 | June 2018 | Lizandara et al |

### Non-Patent Literature Documents

Alamer, A.: CO₂ conversion by reverse water gas shift reaction, Master's Thesis, UCLA Chemical Engineering (2018).
Artz, J., Müller, T.E., Thenert, K., Kleinekorte, J., Meys, R., Sternberg, A., Bardow, A, Leitner, W: Sustainable conversion of carbon dioxide: An integrated review of catalysis and life cycle assessment. Chemical Reviews, 118, 434-504 (2018).
Bahmanpour, A. M., Heroguel, F., Kilic, M., Baranowski, C. J., Artiglia; L.: Cu—Al spinel as a highly active and catalyst for the reverse water gas shift reaction. ACS Catal., 9, 6243-6251 (2019).
Bahmanpour, A. M, Signorile, M., Krocher, O.: Recent progress in syngas production via catalytic CO₂ hydrogenation reaction, Applied Catalysis B: Environmental, 295, 120319 (2021).
Centi, G., Perathoner, S.: Opportunities and prospects in the chemical recycling of carbon dioxide to fuels. Catalysis Today, 148, 191-205 (2009).
Chen, J. G., Catalytic reduction of CO₂ by H₂ for synthesis of CO, Catalysis Letters, 91 (3), 247-252 (2003).
Chen, P., Zhao, G., Shi, X-R., Zhu, J., D-J., Lu, Y.: Nano-intermetallic InNi₃C_{0.5} compound discovered as a superior catalyst for CO₂ re-utilization, iScience,17, 315-324 (2019).
Chen, X., Chen, Y., Song, C., Ji, P., Wang, N., Wang, W., Cui, L.: Recent advances in supported metal catalysts and oxide catalysts for the reverse water-gas shift reaction, Front. Chem., 8, 1-21 (2020).
Choi, S., Sang, B-I., Hong, J., Hong, J., Yoon, K.J., Son, J., Lee, J-H, Kim, B-K., Kim, H.: Catalytic behavior of metal catalysts in high temperature RWGS reaction: In-situ FT-IR experiments and first-principles calculations, Scientific Reports, 1-10 (2017).
Daza, Y.A., Kuhn, J. N.: CO₂ conversion by reverse water gas shift catalysis: Comparison of catalysts, mechanisms, and their consequences for CO₂ conversion to liquid fuels, Royal Society of Chemistry Advances, 6, 49, 675-49,691 (2016).
Debek, R., Motak, M., Galvez, M.E., Da Costa, P. and Grzybek, T.: Catalytic activity of hydrotalcite-derived catalysts in the dry reforming of methane: On the effect of Ce promotion and feed gas composition, Reaction Kinetics, Mechanisms and Catalysis, 121, 185-208 (2017).
Figueras F.: Basicity, catalytic and adsorptive properties of hydrotalcites. In: Gil A., Korili S., Trujillano R., Vicente M. (eds), Pillared Clays and Related Catalysts. Springer, New York, N.Y. (2010)
Fischer, N., Claeys, M., Van Steen, E., Niemantsverdriet, H., Vosloo, M.: Syngas convention—fuels and chemicals from synthesis gas: state of the art, 2, 1-200 (2016).
Goncalves, R. V., Vono, L. R., Wojcieszak, R., Carlos, S. B., Heverton-Wender, S. B. D., Liane, E. T. N., Rossi, M., Selective hydrogenation of CO₂ into CO on a highly dispersed nickel catalyst obtained by magnetron sputtering deposition: A step towards liquid fuels, Applied Catalysis B: Environmental, 209, 240-246 (2017).
Gumber, S., GurumoOrthy, A. V. P.: Methanol economy versus H₂ economy, in Methanol: Science and Engineering. Basile, A., Dalena, F., editors. Elsevier; Amsterdam, The Netherlands 661-674 (2018).
He, Y., Yang, K. R., Yu, Z., Fishman, Z. S., Achola, L. A., Tobin, Z. M., Heinlein, J. A., Hu, Shu, Suib, S. L., Batista, V., Pfefferle, L. D: Catalytic manganese oxide nanostructures for the reverse water gas shift reaction, Nanoscale, 11, 16677-16688 (2019).
Hepburn, C., Adlen, E., Beddington, J., Carter, E. A., Fuss, S., Dowell, N. M., Minx, J. C., Smith, P., Williams, C. K.: The technological and economic prospects for CO₂ utilization and removal, Nature, 575, 87-97 (2019).
Ishito, N., Hara, K., Nakajima, K., Fukuoka, A.: Selective synthesis of carbon monoxide via formates in reverse water-gas shift reaction over alumina-supported gold catalyst, Journal of Energy Chemistry, 25, 306-310 (2016).
Jatav, J., Jatav, R., Bhardwaj, S. K., Sahu, P. K., Kumar, K, Journal of Chemical and Pharmaceutical Research, 8, 678-696 (2016).
Jiang, Z., Xiao, T., Kuznetsov, V. L., Edwards, P. P.: Turning carbon dioxide into fuel. Phil. Trans. R. Soc. A, 368, 3343-3364 (2010).
Kharaji, A. G., Takassi, M. A., Shariati, A.: Activity and Stability of Fe-V2O5/γ-Al2O3 Nano-catalyst in the Reverse Water Gas Shift (RWGS) Reaction, 2012 International Conference on Environmental Science and Technology, Singapore, 30 (2012).
Kharaji, A. G., Shariati, A., Ostadi, M.: Development of Ni—Mo/Al₂O₃ catalyst for reverse water gas shift (RWGS) reaction, Journal of Nanoscience and Nanotechnology,14, 6841-6847 (2014).
Kim, S. S., Lee, H. H., Hong, S. C.: The effect of the morphological characteristics of TiO₂ supports on the reverse water-gas shift reaction over Pt/TiO₂ catalysts, Applied Catalysis B: Environmental, 119-120, 100-108 (2012).
Kim, D. H., Park, J. L., Park, E. J., Kim, Y. D., Uhm, S.: Dopant effect of barium zirconate-based perovskite-type catalysts for the intermediate-temperature reverse water gas shift reaction, ACS Catalysis, 4, 3117 (2014).
Lin, J., Hu, C., Xu, X., Shao, M., Hu, Y., Ma, C.: Investigation of various metals on hydrotalcite-based Cu/Zn/Al catalysts in methanol steam reforming, Chemical Engineering Technology, 44, 1121-1130 (2021).
Lortie, M.: Reverse water gas shift reaction over supported Cu—Ni nanoparticle catalysts, Department of Chemical and Biological Engineering M.S. Thesis, University of Ottawa, Ottawa, Canada (2014).
Lu, B., Kawamoto, K.: Preparation of mesoporous CeO₂ and monodispersed NiO particles on CeO₂, and enhanced selectivity of NiO—CeO₂ for reverse water gas shift reaction, Materials Research Bulletin, 53, 70-78 (2014).
National Academy of Sciences (NAS): Chemical Utilization of CO₂ into Chemicals and Fuels, Gaseous Carbon Waste Streams Utilization: Status and Research Needs, National Academies Press, Washington D.C. (2019).
Pastor-Pérez, L., Baibars, F., Le Sache, E., Arellano-García, H., Gu, S., Reina, T. R.: CO₂ valorization via reverse water-gas shift reaction using advanced Cs doped Fe-Cu/Al₂O₃ catalysts, Journal of CO₂ Utilization, 21, 423-428 (2017).
Pastor-Perez, L., Shah, M., Le Sache, E., Ramierez-Reina, T.: Improving Fe/Al₂O₃ catalysts for the reverse water-gas shift reaction: On the effect of Cs as activity/selectivity promoter, Catalysts, 6, 608-622 (2018).
Pines, H., Haag, W.O.: Alumina, its intrinsic acidity and catalytic activity, J. Am. Chem. Soc., 82, 10, 2471-2483 (1960).
Ranjbar, A., Aghamire, S. F., Irankhah, A.: Effect of MgAl₂O₄ catalyst support synthesis method on the catalytic activity of nickel nano catalyst in reverse water gas shift reaction, Iranian Journal of Chemical Engineering,16, 58-69 (2019).
Schuetzle, D., Tamblyn, G., Caldwell, M., Schuetzle, R.: Solar reforming of carbon dioxide to produce diesel fuel. U.S. Department of Energy report #DE-FE0002558 (2010).
Schuetzle, D., Tamblyn, G., Caldwell, M., Hanbury, O., Schuetzle, R., Rodriquez, R., Johnson, A., Deichert, F., Jorgensen, R., Struble, D: Demonstration of a pilot integrated biorefinery for the efficient, direct conversion of biomass to diesel fuel. DOE Technical Report #DE-EE0002876, U.S. Department of Energy Bioenergy Technologies Office (DOE-BTO), Golden, CO, 1-261 (May 2015) (www.researchgate.net)
Schuetzle, D.: Historical and predicted global climate changes and some potential accelerated climate moderation approaches, 2018 Global Climate Action Summit, San Francisco, CA, 1-42 (2020) (www.researchgate.net).
Shukla, P. R. et al: Climate Change and Land: an IPCC special report on climate change, desertification, land degradation, sustainable land management, food security, and greenhouse gas fluxes in terrestrial ecosystems, 2019 Intergovernmental Panel on Climate Change (2019) (www.ipcc.ch)
Sikander, U., Sufian, S., Salam, A.: A review of hydrotalcite based catalysts for hydrogen production systems, International Journal of Hydrogen Energy 42 (2017)
Sun, F-M., Yan, C-F., Wang, Z-D., Guo, C-Q., Huang, S-L.: Ni/Ce on Zr-0 catalyst for high CO₂ conversion during reverse water gas shift reaction (RWGS), International Journal of H₂ Energy, 40 (46), 15985-15993 (2015)
Tan, E. C. D., Schuetzle, D., Zhang, Y., Hanbury, O., Schuetzle, R.: Reduction of greenhouse gas and criteria pollutant emissions by direct conversion of associated flare gas to synthetic fuels at oil wellheads, International Journal of Energy and Environmental Engineering, 9, 305-321 (2018).
Vogt, C., Monai, M., Kramer, G. J., Weckhuysen, B. M.: The renaissance of the Sabatier reaction and its applications on Earth and in space, Nature Catalysis, 2, 188-197 (2019).
Wang, L., Zhang, S., Liu, Y., Reverse water gas shift reaction over Co-precipitated Ni-CeO₂ catalysts, Journal of Rare Earths, 26,1, 66-70 (2008).
Wang, Y., Liu, T., Lei, L., Chen, F.: High temperature solid oxide H₂O/CO₂ co-electrolysis for syngas production, Fuel Processing Technology, 161 (2016).
Wang, L., Liu, H., Chen, Y., Yang, S.: Reverse water-gas shift reaction over co-precipitated Co—CeO₂ catalysts: Effect of Co content on selectivity and carbon formation, International Journal, 42, 6, 3682-3689 (2017).
Yang, L., Pastor-Perez, L., Gua, S., Sepulveda-Escribanob, A, Reina, T. R.: Highly efficient Ni/CeO₂—Al₂O₃ catalysts for CO₂ upgrading via reverse water-gas shift: Effect of selected transition metal promoters, Applied Catalysis B: Environmental, 232, 464-471 (2018).
Zhang, X., Zhu, X., Lin, L., Yao, S., Zhang, M., Liu, X., Wang, X., Li, Y.-W., Shi, C., Ma, D.: Highly dispersed copper over β-Mo₂C as an efficient and stable catalyst for the reverse water gas shift (RWGS) reaction, ACS Catalysis (2016).
Zhang, L. et al: Active and stable MgAl₂O₄ and Ni on MgAl₂O₄ catalysts for RWGS reactions, Tsinghua University, Beijing (2021).
Zhuang, Y.: Renewable syngas generation and biogas/landfill gas upgrade via thermocatalytic conversion of carbon dioxide, M.S. Thesis, University of Waterloo, Chemical Engineering (2017).

1-15. (canceled)

16. A process for the production of syngas comprising: reacting a feedstock comprising a mixture of hydrogen and carbon dioxide in a catalytic reactor including a catalyst, wherein the catalyst comprises the following: a chemical composition which contains no precious metals chosen from the group Rh, Pt, Au, Ag, Pd, or Ir, wherein the catalyst has a hardness of between 4 Mohs and 10 Mohs, wherein the catalyst is chemically and physically stable at temperatures of 2,100° F. such that after a thermal treatment at 2,100° F., the BET surface area of the catalyst is within between 0 and 5% of the pre-treatment surface area, wherein the catalyst can be loaded readily into catalytic reactors where the pressure drop from the inlet to the outlet of the catalytic reactor is between 0 and 50 psi, wherein the catalyst can convert CO₂ to CO where the CO₂ conversion is between 70% and 100% at a temperature between 1,300° F. and 1,800° F. and pressures above 50 psi and wherein the catalyst does not coke and during the conversion, and wherein CO₂ conversion declines by between 0 and 1% per 1000 hours of operation, where the catalytic reactor is operated between 1,300° F. and 1,800° F. at a pressure from 50 psi to 450 psi, thereby producing a product stream from the catalytic reactor comprising CO.

17. The process of claim 16 where the feedstock comprises H₂/CO₂ ratio of 1.5 to 4.0.

18. The process of claim 16 where the catalyst does not coke.

19. The process of claim 16 in wherein the catalytic reactor is operated at temperatures between 1,300° F. and 1,800° F.

20. The process of claim 16 wherein the product stream is further reacted to produce at least one of the following products chosen from the list consisting of liquid fuels, methanol, propane, naphtha, and chemicals
